(19) United States
(12) Patent Application Publication
(10) Pub. No.: US 2013/0054156 A1
(43) Pub. Date: Feb. 28, 2013

(54) STRAIN MEASURING AND MONITORING DEVICE

(71) Applicant: Andrew Hyett, Glenburnie (CA)

(72) Inventor: Andrew Hyett, Glenburnie (CA)

(73) Assignee: YieldPoint Inc., Kingston (CA)

(21) Appl. No.: 13/596,115

(22) Filed: Aug. 28, 2012

Related U.S. Application Data
(60) Provisional application No. 61/529,601, filed on Aug. 31, 2011.

(51) Int. Cl. G01B 7/16; G06F 19/00

(52) U.S. Cl. 702/42; 73/779

(57) ABSTRACT

The present disclosure provides a strain measuring and monitoring device with displacement sensors for measuring and monitoring the levels of strain and load forces experienced by metallic bars, such as reinforcing bars or rock bolts. The strain measuring and monitoring device includes an array of displacement sensors that directly measure the induced displacement or stretch of the metallic bar being measured over an extended base length. Upon dividing the measured displacement by this longer base-length, an average strain is determined.

### RELATED APPLICATION

This application claims the benefit under Title 35, U.S.C., S.119(e) of U.S. Provisional Application No. 61/529,601 filed on Aug. 31, 2011, which is herein incorporated by reference.

### TECHNICAL FIELD

This disclosure relates to strain measuring and monitoring devices and particularly devices for measuring and monitoring the levels of strain and loads experienced by generally reinforcing bars, such as rock bolts.

### BACKGROUND

Reinforcing bars or “rock bolts” are installed in mines to provide reinforcement to a rock mass and prevent ground falls. Types of rock bolts include “fully grouted” bolts and “end-anchored” bolts. Whereas for an end-anchored bolt the tension in the bolt is constant over its length, for a fully grouted bolt the load distribution is more complex and varies depending on factors such as (i) the physical properties of the bolt, (ii) the installation procedure, (iii) the epoxy resin bond between the bolt and the rock borehole and (iv) the distribution of movement in the rock mass surrounding the bolt.

Whereas early research efforts combined theoretical and experimental research, in recent years the research emphasis has become progressively biased towards theoretical and numerical investigations. There exists a need for additional practical work and specifically, measuring and monitoring devices with instrumentation for precisely and accurately measuring the strain to which the rock bolt is subjected.

### SUMMARY

The present disclosure describes a strain measuring and monitoring device for measuring and monitoring the levels of strain and loads experienced by generally inflexible metallic bars, such as rock bolts. The strain measuring and monitoring device is based on an array of displacement sensors that directly measure the induced displacement or stretch of the metallic bar being measured over an extended base length. Upon dividing the measured displacement by this longer base-length, an average strain is determined. Based on the material properties of the metallic bar being measured the average strain can be related to the load. The strain measuring and monitoring device of the present disclosure may be implemented to provide measurements for experimental and theoretical research or to provide a commercial monitoring solution for metallic bars that are commonly used in industry and subjected to strain and load, such as rock bolts.

According to an embodiment of the present disclosure there is provided a strain measurement and monitoring device. The device comprises a metallic bar having an elongate shaft; at least two longitudinal cavities formed within the shaft; and a plurality of displacement sensors provided in the at least two longitudinal cavities. The displacement sensors are configured to measure the displacement of one point of the shaft relative to a reference point of the shaft.

According to another embodiment of the disclosure there is provided a method of determining strain experienced by a metallic bar. The method comprises providing a plurality of displacement sensors in at least two longitudinal cavities formed within the metallic bar; measuring the displacement of at least one point of the metallic bar relative to a reference point of the metallic bar; and determining the strain experienced by the metallic bar using the measured displacements.

According to another embodiment of the disclosure there is provided a system for measuring strain experienced by a metallic bar. The system comprises a plurality of displacement sensors adapted to be fixedly attached to a metallic bar for measuring displacement of points on a surface of the metallic bar relative to reference points; and a microcontroller operatively connected to the plurality of displacement sensors. The microcontroller is configured to receive displacement values measured by the plurality of displacement sensors, store calibration data and determine the strain experienced by the metallic bar.

### BRIEF DESCRIPTION OF THE FIGURES

FIG. 1 is a plan view of an embodiment of a measuring and monitoring device of the present disclosure.

FIG. 2 is a cross-sectional perspective view of the metallic bar of FIG. 1, taken along the line 2-2′.

FIGS. 3a, 3b, and 3c are isometric view and cross-sectional views, respectively, of an inductive displacement sensor for use in some embodiments of the measuring and monitoring device of the present disclosure. FIGS. 3d and 3e are side views of measuring and monitoring devices according to the present disclosure.

FIG. 4 is a perspective view of a portion of one embodiment of the measuring and monitoring device of the present disclosure.

FIGS. 5a and 5b are side views of alternative embodiments of the measuring and monitoring device of the present disclosure.

FIG. 6 is a block diagram of one embodiment of a microcontroller for use with some embodiments of the measuring and monitoring device of the present disclosure.

FIGS. 7a, 7b, 7c and 7d are additional side views of the embodiments depicted in FIGS. 5a and 5b.

FIGS. 8a and 8b are graphs showing the results of testing of some embodiments of the present disclosure.

FIG. 9 is a diagram illustrating one embodiment of the present disclosure under load testing.

### DETAILED DESCRIPTION OF THE EXAMPLE IMPLEMENTATIONS

Instrumenting reinforcing bars such as rock bolts involves a compromise between the number of gauges (i.e. cost) and the accuracy with which the strain profile along the rock bolt is resolved. Final instrument cost is important since a percentage of instrumented bolts will be lost to production related attrition, firstly because the installation process involves spinning the grouted bolt in epoxy resin, and thereafter because, at the mine production face, the proximity of heavy machinery presents an ongoing hazard.

Optimizing the measurement of the load distribution along the bolt using a discrete number of gauges depends on:

(i) the number of gauges;
(ii) the base-length of the gauges; and
(iii) the accuracy and resolution of the gauges.

Previously, attempts at instrumenting rock bolts for measuring the strain in the bolt have depended on short base-length, typically less than 30 mm, resistive strain gauges adhered into grooves machined along the length of the bolt. To compensate for any bending or shear deformation, diametrically opposed grooves or slots are populated with pairs of strain gauges. Typically the bolt is populated with six pairs of diametrically opposed strain gauges.

However, there exists a number of limitations when using resistive strain gauges such as bonded foil resistive strain gauges. For example, in configurations using six pairs of diametrically opposed strain gauges as described above, less than 10% of the total bolt is monitored and the short base lengths are likely to be strongly influenced by any localized deformation which may overshadow the general axial performance of the bolt.

As well, the small resistance changes and corresponding small voltage changes associated with strain gauge technology are susceptible to the harsh environments of rock bolt installations, such as mining environments, especially when the technology is used in production settings by operators less skilled in the art of instrumentation.

Furthermore, the array of resistive strain gauges may require a lead-wire with as many as thirty electrical conductors which, if damaged by rock movements or mining equipment, will require significant time and effort to repair.

Several limitations are encountered when the load on the rock bolt being measured passes the yield point of the steel from which it is made. Readings from the resistive strain gauges are inaccurate past 5,000 microstrain in such a condition. As well, the bolt head can stretch under such conditions, sometimes more than two (2) inches. Such a deformation can cause the lead wires to the strain gauges to stretch and break. The stretching of the lead wires changes the resistance, which changes the relationship between electrical readings and load. Furthermore, as the rock bolt stretches as the load to which it is subject passes yield point, the strain gauges can become “debonded” from the bolt, due to the stretching of the bolt and strain gauges.

Another limitation encountered when using resistive strain gauges is that every gauge on the bolt has to be calibrated using an axial pull test and the coefficients must be applied later during the analysis of the data. Without these coefficients, data cannot be presented, for example, to interested underground personnel and therefore the technology does not provide a direct measurement of the load level existing on the bolt to an underground miner, who would benefit from an assessment of risk. Furthermore, it may not be possible to implement an alarm system underground.

A further limitation is that the expertise required to meticulously adhere strain gauges to the bolts results in an expensive end-product. This is an important factor prohibiting widespread commercialization of existing technologies.

The strain measuring and monitoring device of the present disclosure comprises a metallic bar, a plurality of displacement sensors and in some embodiments, a microcontroller. The plurality of displacement sensors are disposed in at least two longitudinal cavities formed in the metallic bar. In one embodiment, the plurality of displacement sensors are operatively connected to the microcontroller which determines the strain on the metallic bar based on the measured displacements and calibration data stored in the microcontroller.

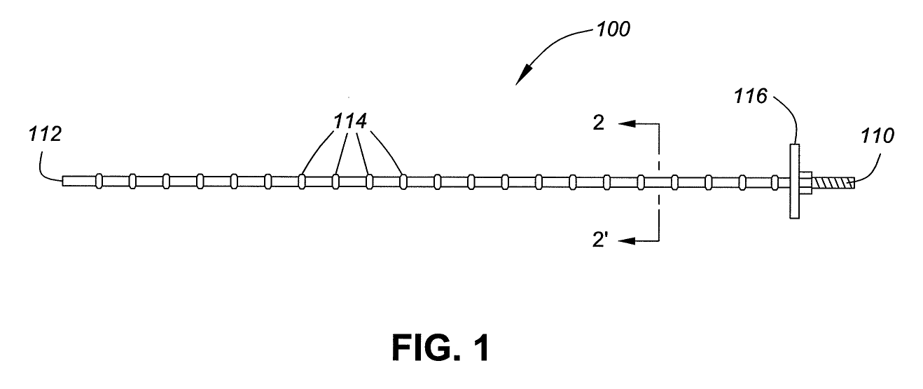

Referring now to FIG. 1, one example embodiment of the strain measuring and monitoring device 100 of the present disclosure is shown. The device 100 comprises a metallic bar 110 which in some embodiments, can be any fully grouted rock bolt of the type that is commonly known in the industry. The example embodiment depicted in FIG. 1 comprises a metallic bar 110 having an elongate metallic shaft 112 with a plurality of ribs 114 formed in the exterior wall of the shaft 112. A plurality of displacement sensors 310 and, in some embodiments, a microcontroller 610 are disposed within the metallic bar 110 and are not visible in the view of FIG. 1. A faceplate 116 is also provided which circumscribes the shaft 112 adjacent a proximal or “head” end of the metallic bar 110. The distal end of the metallic bar 110 also may be referred to as the “toe” end. The faceplate 116 contacts the rock face once the metallic bar 110 has been inserted into the rock. As well, in some embodiments, the metallic bar 110 has a threaded end (not shown) for insertion into a threaded receiving socket (not shown).

Although the example embodiments of the strain measuring and monitoring device 100 are discussed in examples below with respect to rock bolts, it will be appreciated by those of ordinary skill in the art that the strain measurement and monitoring device 100 of the present disclosure can be used in association with any sort of metallic bar structure, such as concrete rebar, hollow cables and other flexible steel tendons such as cable bolts and is not limited to the measurement and monitoring of strain in rock bolts.

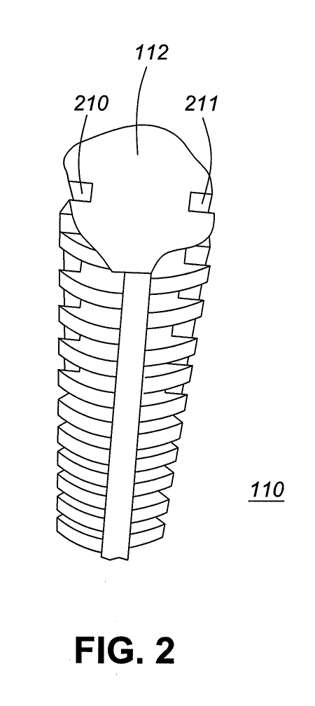

Referring now to FIG. 2, in some embodiments the shaft 112 of the metallic bar 110 has two longitudinal cavities comprised of diametrically opposed grooves 210, 212 formed in the bar 110, for receiving the plurality of displacement sensors 310. As shown in FIG. 2, in some embodiments the grooves 210, 212 are equidistant from each other along the circumference of the shaft 112. The grooves 210, 212 can be formed using any suitable machining method for cutting into the metallic material of the metallic bar 110. The grooves 210, 212 can be formed in any shape having dimensions suitable for receiving a displacement sensor 310. In some embodiments, the grooves 210, 212 are formed in the outer surface or wall of the metallic bar 110, as show in FIG. 2, and have a substantially square cross-section, with a width of 3.2 mm and a depth of 3.2 mm.

In some embodiments, the grooves 210, 212 run the entire length of the shaft 112 of the metallic bar 110, and are open at each end of the shaft 112. In some embodiments, the grooves 210, 212 run along only a portion of the shaft 112 of the metallic bar 110, and are open at only one end of the shaft 112. In some embodiments, the grooves 210, 212 run along only a portion of the shaft 112 of the bolt, and are not open at either end of the shaft 112.

In some embodiments, a plurality of holes (not shown) are created in the bottom of the grooves 210, 212 for securing the plurality of displacement sensors 310 to the grooves 210, 212. In some embodiments, the holes are 1.0 mm or less in diameter.

The two grooves 210, 212 and the displacement sensors 310 disposed therein allow for compensation or correction of errors related to lateral bending or flexure of the metallic bar 110 as opposed to stretch induced by axial loading. In other embodiments (not shown), three longitudinal cavities or grooves can be used. In some such embodiments, the three grooves are equidistant from each other around the shaft 112 of the metallic bar 110. Such configurations of grooves, and displacement sensors 310 placed therein, allow the measurement of the actual bending vector, both magnitude and direction, experienced by the metallic bar 110.

The plurality of displacement sensors 310 can be any type of electrical or optical displacement sensor that is commonly known in the art, so long as the sensor's size is such that the sensor can be provided in the longitudinal cavity of the metallic bar 110. Several such sensors 310 are commonly known, such as capacitive displacement sensors and inductive, or eddy current displacement sensors.

The resolution capabilities of the displacement sensors 310 used can be selected based on the expected amounts of strain to be measured. For example, to measure strain corresponding to displacement in the range of 0 to 2500 microns, sensors 310 having resolution capabilities no worse than one micron should be used. In some embodiments of the measuring and monitoring device 100 of the present disclosure, displacement sensors 310 having sub-micron resolution are used.

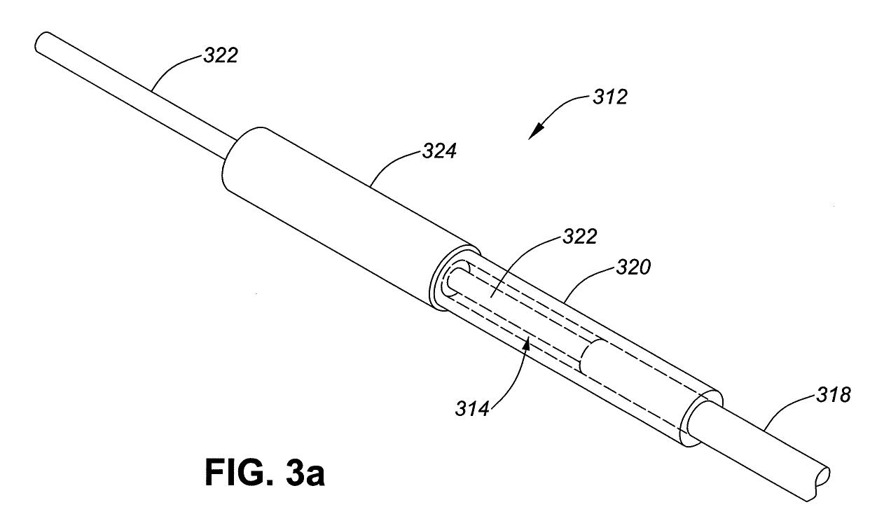

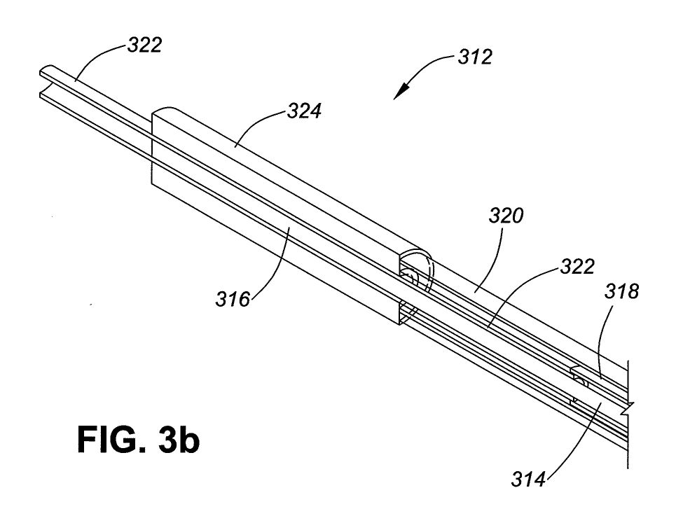

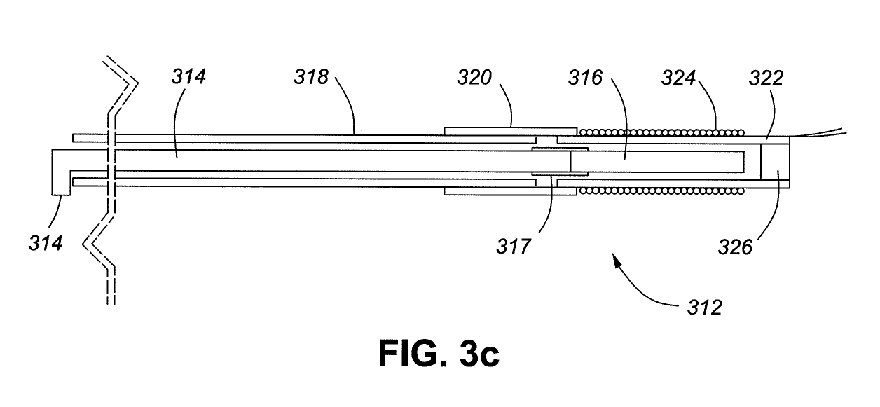

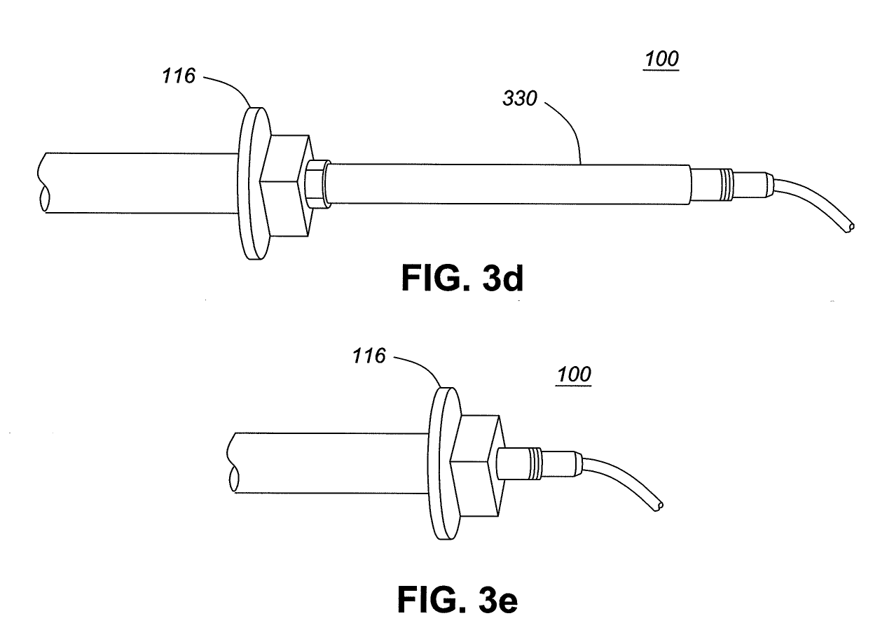

In some embodiments, the plurality of displacement sensors 310 comprise inductive sensors 312, as illustrated in FIGS. 3a, 3b and 3c. In some embodiments, each inductive sensor 312 comprises a stainless steel wire 314, typically 300 mm to 500 mm in length and 0.63 mm (0.025″) in diameter. One end of the wire is bent at an angle, such as ninety degrees, and secured into a hole (not shown) drilled in one of the grooves 210, 212. The other end of the wire 314, which is free, is attached to a high magnetic permeability wire 316, such as with a coupler 317. In one embodiment, the high magnetic permeability wire 316 has a diameter of 0.63 mm and a length of 25 mm. The high magnetic permeability wire 316 moves freely within an induction coil 324.

In one embodiment, the induction coil 324 is wound on a tube, such as a polyimide tube 322. Both the steel wire 314 and the high magnetic permeability wire 316 are encased in a tubular steel cover 318, which is attached to the polyimide tube 322 by a flexible silicone tube 320 so as to isolate the wires 314 and 316 when the whole displacement sensor 312 is bonded into the groove 210, 212. In some embodiments, the induction coil 324 is wound in six layers. A plug 326 is provided at the proximal or head end of the metallic bar 110. In some embodiments of the strain measuring and monitoring device 100, an additional compartment housing 330 as shown in FIG. 3d is provided to house electronic components such as the microcontroller 610. In other embodiments, electronic components are attached via the plug 326 as shown in FIG. 3e.

In the embodiments utilising the inductive sensor 312 described above, the high magnetic permeability wire 316 moves freely within the induction coil 324, generating an electrical signal in the coil 324 that is proportional to the displacement of the high magnetic permeability wire 316 within the coil 324. Using such a configuration, stretch or compression of the sensor 312 requires no force since there is no physical contact between the ends of the sensor 312. The high magnetic permeability wire 316 moves within the induction coil 324 which changes the impedance of the electrical circuit and modulates the output signal of the sensor 312. Upon loading, stretch of the metallic bar 110 causes displacement of the coil 324 relative to the wire 316. The corresponding change in coil inductance causes a variation in frequency of a resonant electrical circuit which is measured by the microcontroller 610. Movement of the inductive sensor 312 during axial loading requires no force since the inductive sensing technology is contactless, and hence there is no tendency to slip or creep over time.

In embodiments of the present disclosure wherein the displacement sensors 310 have end points defining a base length typically in the range of 300-500 millimetres, or up to 2000 mm, the base length of the sensor 310 is more than an order of magnitude longer than that of typical resistive strain gauges and therefore allows for the measurement of displacement and thus strain over a larger portion of the shaft 112 of the metallic bar 110. Furthermore, in some embodiments, such long base length displacement sensors 310 are placed end-to-end along the entire length of the shaft 112 of the metallic bar 110. By using configurations such as these, displacement measurements, and ultimately strain measurements, are much less susceptible to influence by localized perturbations and provide a more accurate picture of the strain to which the metallic bar 110 is subject.

As well, for embodiments utilising the inductive sensor 312 described above, the inductive sensor 312 can monitor up to 5.0% (50,000 microstrain) strain, which is higher than conventional resistive foil strain gauges.

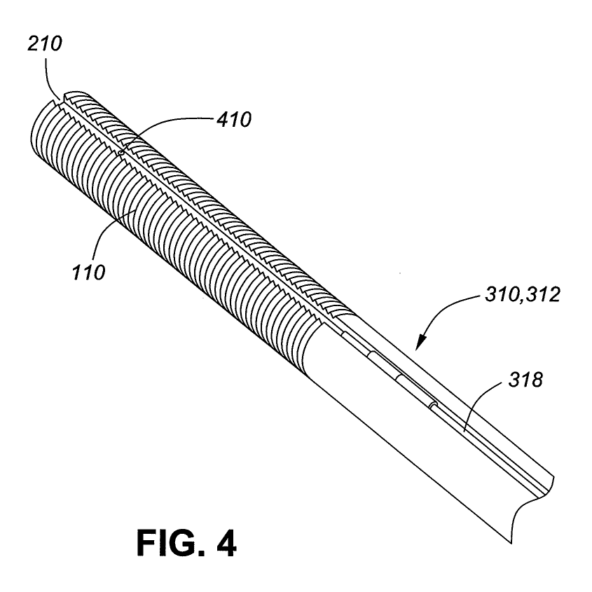

As shown in FIG. 4, displacement sensors 310, 312 are mounted to the metallic bar 110 by inserting the displacement sensors 310, 312 in the grooves 210, 212. In some embodiments, once the displacement sensors 310, 312 are positioned into the grooves 210, 212, and wires with output signals from the sensors 310 are routed, as discussed in greater detail below, the sensors 310, 312 are bonded in place using a strong epoxy resin. The cover 318 decouples the inner wire from the encapsulating epoxy resin and allows the high magnetic permeability wire 316 to translate within the induction coil 324.

In some embodiments, the metallic bar 110 can be provided with a hole 410 to facilitate the passage of wiring associated with either the displacement sensors 310, 312 or the microcontroller 610 out of the strain measuring and monitoring device 100. The routing of electrical wires will be discussed in greater detail below.

The number of displacement sensors 310 to be used can be selected based on the accuracy of the displacement measurements required, subject to limitations such as cost, and physical limitations relating to the size of wires that will transmit data from the sensors 310 to the microcontroller 610. A minimum of two displacement sensors 310 are used with one sensor 310 provided in each groove 210, 212. In some embodiments, a total of six displacement sensors 310 are used. In some embodiments, the size of the wires that carry data from the sensors 310 to the microcontroller 610, relative to the size of the grooves 210, 212 and the hole 410 through which the wires will run, limits the total number of possible displacement sensors 310 to twelve.

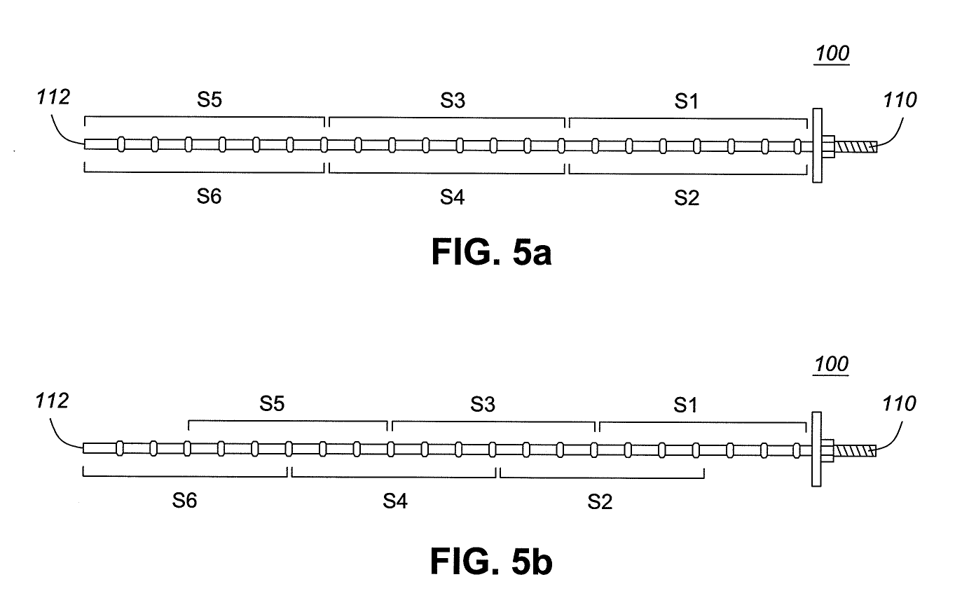

The displacement sensors 310 can be arranged in the grooves 210, 212 in different configurations. In one embodiment, the displacement sensors 310 are placed in a “stacked” configuration, shown in FIG. 5a. In an example stacked configuration, six displacement sensors 310 are provided in the metallic bar 110, three in each of the diametrically opposed grooves 210, 212, in an end-to-end arrangement. The end-to-end arrangement allows strain to be measured and monitored along the entire length of the bar 100. Three displacement sensors 310 are placed in the groove 210 and span lengths of the metallic bar 110 indicated by S₁, S₃ and S₅. Three displacement sensors 310 are placed in the groove 212 and span lengths of the metallic bar 110 indicated as S₂, S₄ and S₆. In other embodiments (not shown), the three displacement sensors 310 in each of the grooves 210, 212 can be spaced apart from one another. As shown in FIG. 5a, each displacement sensor 310 in the stacked configuration is arranged directly opposite a corresponding displacement sensor 310 provided in the other diametrically opposed groove 210, 212.

In other embodiments having two diametrically opposed grooves 210, 212, the displacement sensors 310 can be placed in a “staggered” configuration, shown in FIG. 5b. In some of such embodiments, six displacement sensors 310 are provided on the bar 110, three in each of the diametrically opposed groves 210, 212, in an end-to-end arrangement. The end-to-end arrangement allows strain to be measured and monitored along the entire length of the bar 100. Three displacement sensors 310 are placed in the groove 210 and span lengths of the metallic bar 110 indicated by S₁, S₃ and S₅. Three displacement sensors 310 are placed in the groove 212 and span lengths of the metallic bar 110 indicated as S₂, S₄ and S₆. In other embodiments (not shown), the three displacement sensors 310 in each of the grooves 210, 212 can be spaced apart from one another. In contrast to the stacked configuration, the displacement sensors 310 in one groove 210 are not directly opposite a corresponding displacement sensor 310 in the other 212. Rather, the displacement sensors 310 of one groove 210 are offset from corresponding displacement sensors 310 of the other groove 212. In some embodiments, midpoints of the displacement sensors 310 of one groove 210 are arranged directly opposite the abutting end points of two adjacent displacement sensors 310 of the other groove 212.

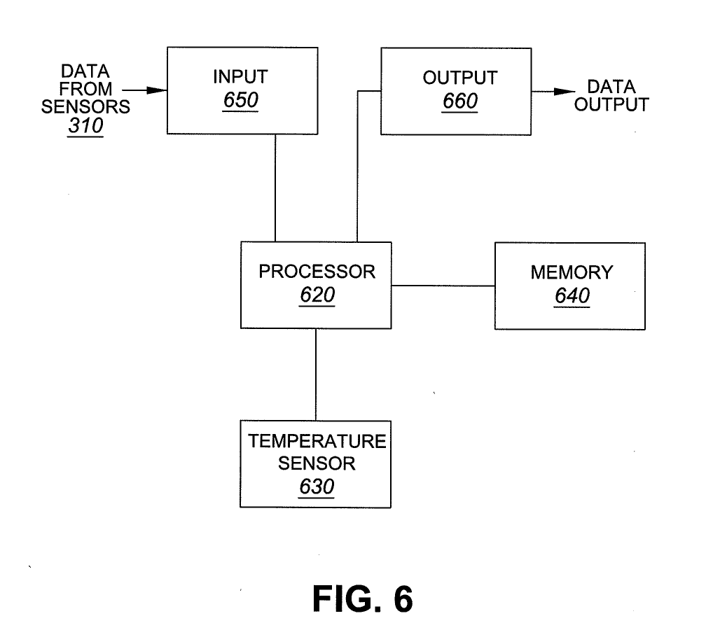

Referring now to FIG. 6, in some embodiments the output signal from the displacement sensors 310 is received by a microcontroller 610 which is configured to determine microstrain in the metallic bar 110 based on the measured displacement values. The microcontroller 610 is disposed in a compartment such as a stainless steel tube or housing 330 or an end plug (not shown) at one end of the metallic bar 110, typically at the head end. Alternatively, a microcontroller 610 may be provided separately or external to the metallic bar 110 and connected via a plug 326. In one embodiment, the microcontroller 610 is detached from the metallic bar 110 during installation and is later reattached or plugged into the end of the metallic bar 110 via a short leadwire that carries the individual sensor signals.

Wires connect the outputs of the displacement sensors 310 to the microcontroller 610. Where the displacement sensor 310 comprises an inductive sensor 312, a connection is made between the induction coil 324 of each inductive sensor 312 to the input 650 of the microcontroller 610. In some embodiments, the wires are routed and arranged within the grooves 210, 212, and are sealed in the grooves 210, 212 using a strong epoxy resin. The wires are routed to the compartment housing 330 for electronics or to the head end of the metallic bar 110 through a central hole (not shown) which access the grooves 210, 212 through holes 410, allowing wires from the sensors 310 to be routed along the grooves 210, 212 and to the electronic components, such as the microcontroller 610.

The microcontroller 610 comprises a processor 620, a temperature sensor 630, a memory 640, an input 650 and an output 660. The microcontroller 610 receives output signals from the sensors 310 via the input 650. The microcontroller 610 and processor 620 are configured to correct the output signals for temperature effects based on the temperature measured by the temperature sensor 630. The processor 620 also applies calibration data and correlation coefficients stored in memory 640 to convert the displacement values measured by the displacement sensors 310 to microstrain. Microstrain values may be stored in the memory 640, transmitted as an output signal via the output 660 or both stored in the memory 640 and transmitted as an output signal. In one embodiment, power is provided to the microcontroller 610 from an external source and is provided via a twisted pair of wires to the input 650.

The output signal may be transmitted over a single twisted pair to a connection or interface with other measuring and monitoring equipment, such as a readout unit or data-logger. In one embodiment, the output signal is transmitted autonomously over a communication network. In some embodiments, the signal from the microcontroller 610 is transmitted via the output 660 over a single twisted pair wire using IEEE RS485 signalling.

Prior to operation, the measuring and monitoring device 100 is calibrated so that strain of the metallic bar 110 can be determined from the measured displacement values. During calibration, the metallic bar 110 is placed in a loading frame and is axially loaded to approximately 75% of its yield strength. At specific loads, output signals from the individual sensors 310 are recorded. Calibration coefficients are determined and stored in the memory 640 of the microcontroller 610. One or more loading cycles may be performed and calibration data typically is collected on the third loading cycle. A final loading cycle that has output results based on the calibration coefficients allows assessment of the accuracy of the measuring and monitoring device 100. An example of the calibration data that can be determined using this method is provided in the table below:

| APPLIED | MEAS. | MEAS. | MEAS. | MEAS. | MEAS. | MEAS. |
|---|---|---|---|---|---|---|
| STRAIN | STRAIN 1 | STRAIN 2 | STRAIN 3 | STRAIN 4 | STRAIN 5 | STRAIN 6 |
| (ue) | (ue) | (ue) | (ue) | (ue) | (ue) | (ue) |
| −0.3 | +0 | +0 | +0 | +0 | +0 | +0 |
| 165.8 | +164 | +166 | +167 | +166 | +165 | +163 |
| 328.6 | +323 | +327 | +328 | +326 | +325 | +324 |
| 668.6 | +678 | +678 | +680 | +677 | +677 | +673 |
| 992.0 | +990 | +994 | +997 | +993 | +994 | +990 |
| 1323.0 | +1315 | +1319 | +1323 | +1319 | +1320 | +1317 |
| 1652.6 | +1649 | +1653 | +1654 | +1651 | +1653 | +1649 |
| CAL. | 0.9973 | 0.9992 | 1.0017 | 0.9985 | 1.0001 | 0.998 |
| SLOPE | | | | | | |
| CAL. | 0.3247 | 1.5109 | 1.8226 | 1.3188 | 0.4321 | −0.6371 |
| OFFSET | | | | | | |

In operation of one embodiment of the present disclosure, a measuring and monitoring device 100 according to the present disclosure is provided as a rock bolt which is inserted into a rock face and subjected to forces applied by the shifting rock. These forces cause the rock bolt to deform, and the amount of displacement of the rock bolt is measured by the displacement sensors 310 and recorded by the microcontroller 610.

The strain to which the rock bolt is subject can be calculated from the amounts of displacement measured by each of the displacement sensors 310. The corresponding strain (e) for each sensor is determined according to the following relationship:

eⁱ=Δuⁱ/L

where:
Δuⁱ is the displacement measured by the i^{th} displacement sensor 310; and

L is the base length of the i^{th} displacement sensor 310.

The calculation of the strain for the entire rock bolt depends on the configuration of the displacement sensors 310 along the shaft 112 of the metallic bar 110 of the rock bolt.

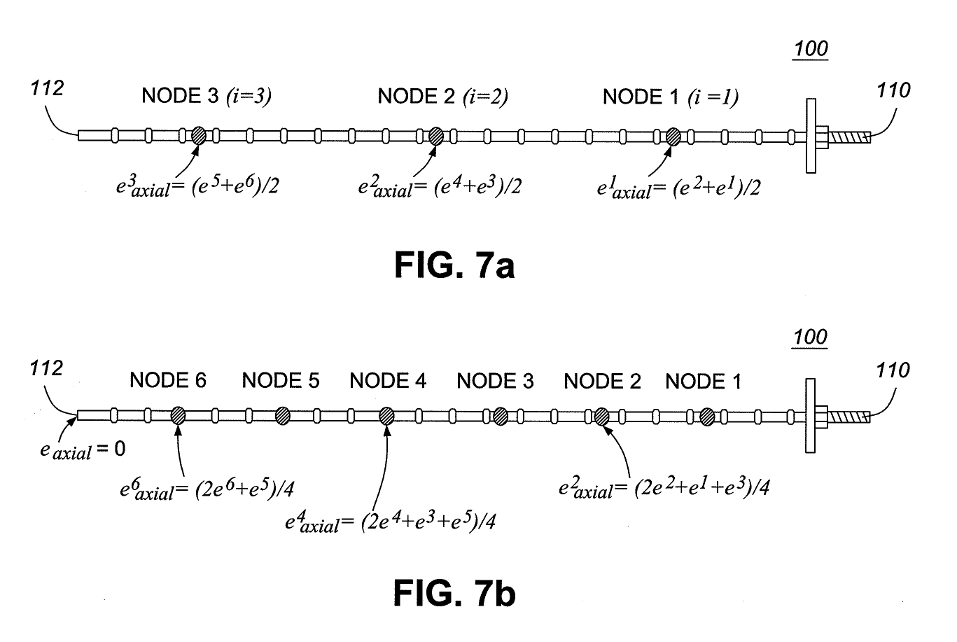

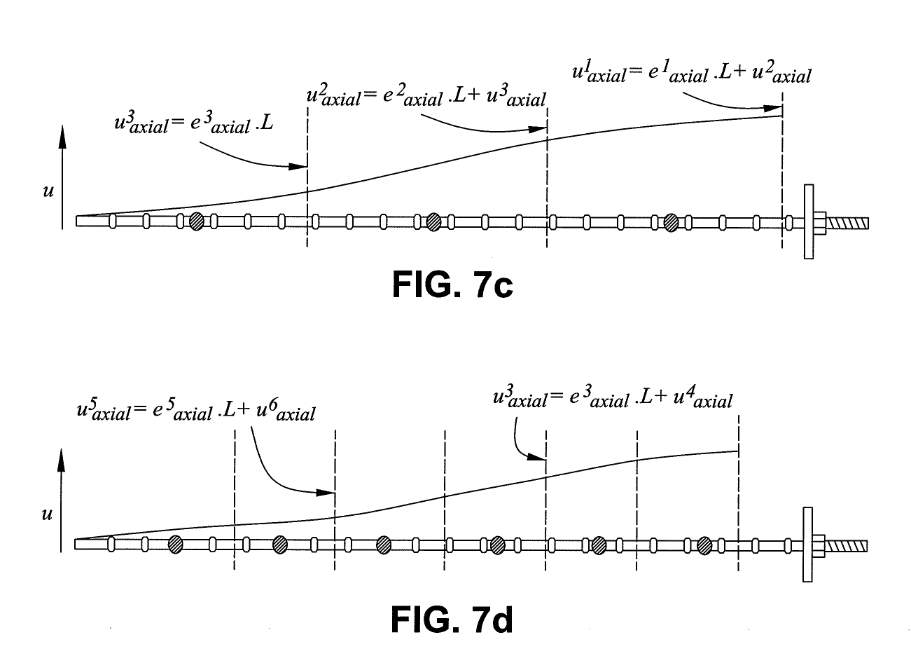

For the stacked configuration, such as the embodiment illustrated in FIGS. 5a, 7a and 7c, the axial strain, that is, the deformation of the rock bolt along the elongate axis of the shaft 112, can be calculated for each of a series of nodal points of strain determination, located at the centre of each pair of directly opposed displacement sensors 310. The axial strain (dₐₓᵢₐₗ) and axial Force Fⁱₐₓᵢₐₗ can be expressed, respectively, as:

eⁱₐₓᵢₐₗ=e²ⁱ⁻¹+e²ⁱ)/2

Fⁱₐₓᵢₐₗ=EAeⁱₐₓᵢₐₗ

where:
E is the Young's Modulus of the material comprising the rock bolt (typically 210 GPa for a steel rock bolt); and
A is the cross-sectional area of the rock bolt.
   In embodiments having a total of six displacement sensors 310 in a stacked configuration, it will be appreciated that there are three nodal points of strain determination, located at the mid-points of each opposing pair of displacement sensors 310, shown as Node 1, Node 2 and Node 3 in FIG. 7a. The value i in the expression above corresponds to the nodal point; that is, i=1 to 3. The strain values on the right hand side of the equation are obtained from the sensors 310 at the locations shown in FIG. 5a. FIG. 7a illustrates the stacked configuration, and the calculations to obtain strain at each of the three nodal points of the stacked configuration.

For a stacked configuration, the bending strain, that is, the deformation of the rock bolt perpendicular to the elongate axis of the shaft 112, may be indicated as:

eⁱ_{bending}=e²ⁱ⁻¹−e²ⁱ)/2

As with the axial strain, in a stacked configuration having six displacement sensors 310 the bending strain can be assessed at three nodal points of strain determination.

In embodiments having six displacement sensors 310 in two directly opposed grooves 210 in a stacked configuration, and with the sensors 310 provided in an end-to-end arrangement, thereby monitoring the whole length of the rock bolt, the displacement profile may be expressed as:

Δuₐₓᵢₐₗⁱ=Σₙ₌₃ⁿ⁼ⁱ(eₐₓᵢₐₗⁱ×L).

The displacement profile and calculations also are illustrated in FIG. 7c. It should be recognised that a distinction is made between the measured displacements (Δuⁱ) from each displacement sensor and the calculated axial displacement Δuₐₓᵢₐₗⁱ, which accounts for any bending.

In embodiments having six displacement sensors 310 in two directly opposed grooves 210 in a staggered configuration, such as the embodiment illustrated in FIGS. 5b, 7b and 7d, the sensors 310 in one of the grooves 210 are offset from those in the other of the grooves 210 by one half the base-length of the sensor. In such a configuration, strain can be evaluated at six nodal points along the length of the shaft 112, with each nodal point being located at the mid-point of each individual displacement sensor 310 (rather than the mid-points of each opposing pair of displacement sensors 310). In this case a data reduction scheme is implemented based on the central difference approximation to the second order governing differential equation for displacement variation along a grouted bolt. The strains at the ith nodal point can be approximated as:

eₐₓᵢₐₗⁱ=(eⁱ⁻¹+2eⁱ+eⁱ⁺¹)/4

e_{bending}ⁱ=(eⁱ⁻¹+2eⁱ+eⁱ⁺¹)/2

where:
eⁱ is the strain calculated from the displacement gauge centered at the ith nodal point; and
eⁱ⁻¹ and eⁱ⁺¹ are the two overlapping gauges on the opposite side of the rock bolt.

At the ends of the rock bolt the following two relations are used. For node 1, the following relation is used:

eₐₓᵢₐₗⁱ=(2e¹+e²)/3,

and for node 6, knowing that eₐₓᵢₐₗ must be zero at the distal or “toe” (opposite to “head”) end of the rock bolt, at the far end of the borehole:

eₐₓᵢₐₗ⁶=(2e⁶+e⁵)/4.

FIG. 7b illustrates the staggered configuration, and the calculation to obtain strain at each of the six nodal points of the staggered configuration.

For a staggered configuration with displacement sensors 310 arranged end-to-end, thereby monitoring the whole length of the rock bolt, the displacement profile at the ith nodal point can be determined from the summation:

Δuₐₓᵢₐₗⁱ=Σₙ₌₆ⁿ⁼ⁱ(eₐₓᵢₐₗⁱ×L/2).

assuming that the toe end of the bolt is fixed. (Δuₐₓᵢₐₗ^{toe}=0). The displacement profile and calculations also are illustrated in FIG. 7d.

In this manner an approximation of axial displacement, strain and load can be determined at six nodal points along the rock bolt. This provides additional axial resolution compared to the “stacked” configuration.

It will be appreciated that, using the staggered configuration, strain and load can be determined at six nodal points along the bolt. This provides additional axial resolution compared to the “stacked” configuration.

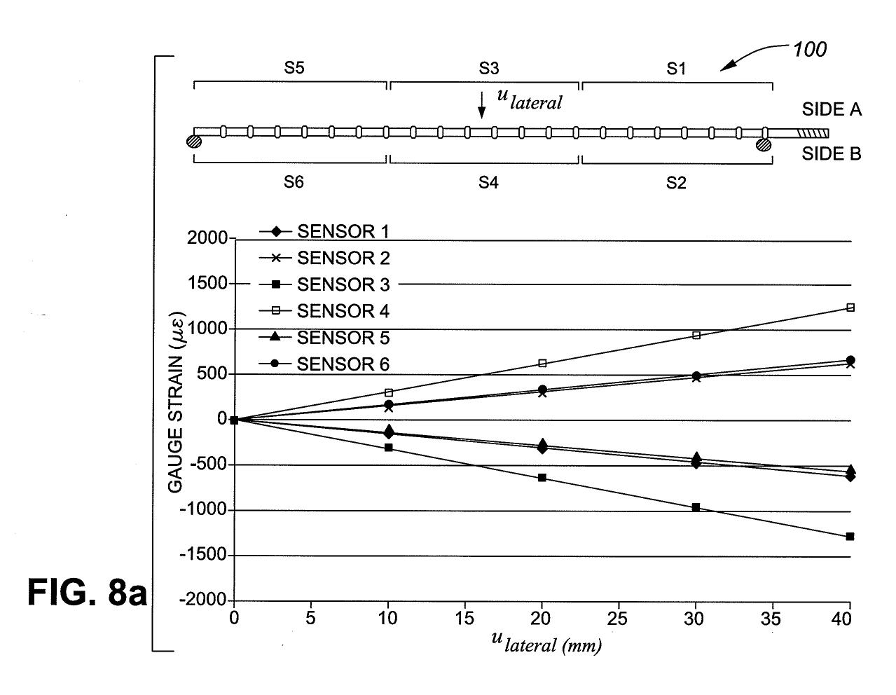

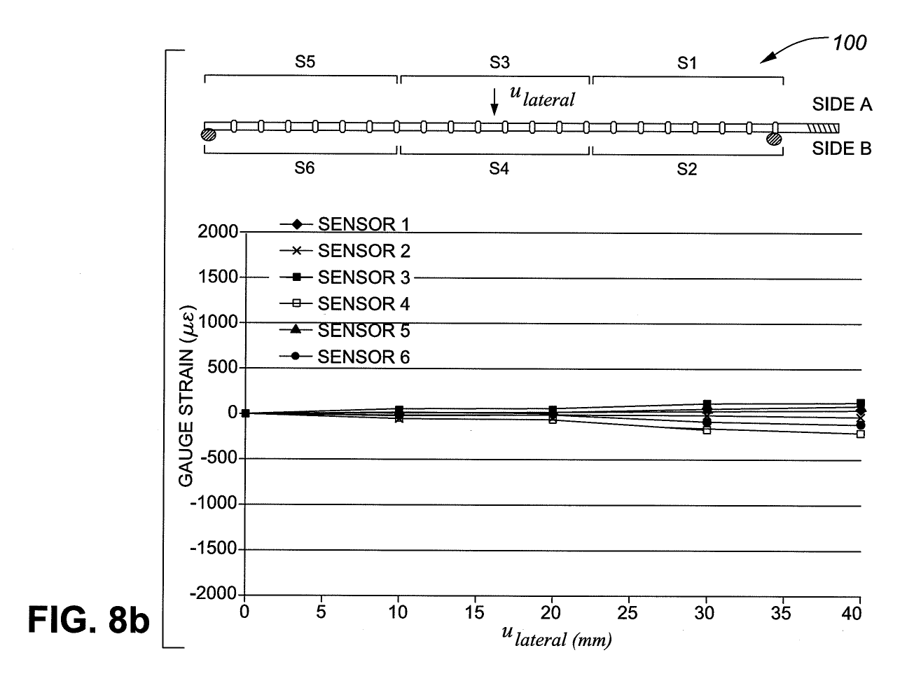

Simple bend tests have been conducted to establish the response of a rock bolt provided with a measuring and monitoring device 100 according to the present disclosure. The results of such testing are shown in FIGS. 8a and 8b. As would be expected from simple beam theory, the displacement sensors 310 on the top of the rock bolt display contraction and those on the bottom demonstrate extension. When the displacement sensors 310 are aligned at the neutral plane they show minimal displacement, as shown in FIG. 8b.

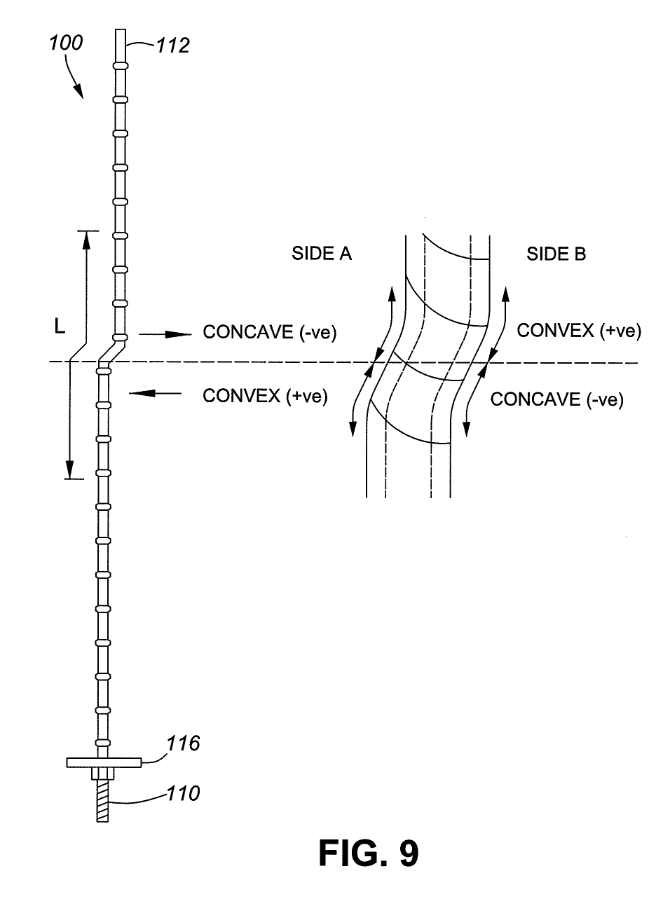

The case for localised shear when the zone of shearing is short compared to the base length of the displacement sensors 310 has also been tested with a rock bolt provided with a measuring and monitoring device 100 according to the present disclosure and the results are shown in FIG. 9. On each side A, B, of the rock bolt the shear zone comprises a convex/concave pair which exhibit corresponding zones of contraction and extension which cancel out. Hence the long base-length sensors will be far less susceptible to perturbation related to localized shear.

It will be apparent to those having ordinary skill in the art that certain adaptations and modifications of the described embodiments can be made, consistent with and without departing from the present disclosure. Unless otherwise indicated, the embodiments described in the disclosure shall be understood to be non-exclusive of each other such that any embodiment can include different features of other embodiments. Therefore, the above discussed embodiments are considered to be illustrative and not restrictive. Other embodiments consistent with the present disclosure will become apparent from consideration of the specification and the practice of the present disclosure taught and suggested herein. Accordingly, the specification and the embodiments disclosed therein are to be considered exemplary only, with the true scope and spirit of the present disclosure being identified in the following claims.

What is claimed is:

1. A strain measurement and monitoring device, comprising:
a metallic bar having an elongate shaft;
at least two longitudinal cavities formed within the shaft; and
a plurality of displacement sensors provided in the at least two longitudinal cavities, the displacement sensors being configured to measure the displacement of one point of the shaft relative to a reference point of the shaft.

2. The strain measurement and monitoring device of claim 1, wherein the device comprises two diametrically opposed longitudinal cavities.

3. The strain measurement and monitoring device of claim 1, wherein the displacement sensors comprise inductive displacement sensor.

4. The strain measurement and monitoring device of claim 3, wherein the inductive displacement sensor comprises an elongate wire and an induction coil circumscribing the elongate wire, wherein the elongate wire is free to move within the induction coil, along an elongate axis of the coil.

5. The strain measurement and monitoring device of claim 4, wherein the elongate wire comprises a high magnetic permeability portion.

6. The strain measurement and monitoring device of claim 4, wherein the induction coil is wound on a polyimide tube, the elongate wire is encased in a tubular steel cover and the tubular steel cover is attached to the polyimide tube by a flexible silicone tube.

7. The strain measurement and monitoring device of claim 1, further comprising a microcontroller operatively connected to the plurality of displacement sensors, wherein the microcontroller is configured to receive displacement values measured by the plurality of displacement sensors and determine the strain experienced by the metallic bar.

8. A method of determining strain experienced by a metallic bar, the method comprising:
providing a plurality of displacement sensors in at least two longitudinal cavities formed within the metallic bar;
measuring the displacement of at least one point of the metallic bar relative to a reference point of the metallic bar; and
determining the strain experienced by the metallic bar using the measured displacements.

9. The method of claim 8, wherein a pair of longitudinal cavities are diametrically opposed within the metallic bar.

10. The method of claim 8, wherein the displacement sensor comprises an inductive displacement sensor.

11. The method of claim 10, wherein the inductive displacement sensor comprises an elongate wire and an induction coil circumscribing the elongate wire, wherein the elongate wire is free to move within the induction coil, along an elongate axis of the coil.

12. The method of claim 11, wherein the elongate wire comprises a high magnetic permeability portion.

13. The method of claim 11, wherein the induction coil is wound on a polyimide tube, the elongate wire is encased in a tubular steel cover and the tubular steel cover is attached to the polyimide tube by a flexible silicone tube.

14. The method of claim 8, wherein determining the strain experienced by the metallic bar based on the displacement measurements is performed by a microcontroller.

15. A system for measuring the strain experienced by a metallic bar, the system comprising:
a plurality of displacement sensors adapted to be fixedly attached to a metallic bar for measuring displacement of points on a surface of the metallic bar relative to reference points; and
a microcontroller operatively connected to the plurality of displacement sensors, the microcontroller being configured to receive displacement values measured by the plurality of displacement sensors, store calibration data and determine the strain experienced by the metallic bar.

16. The system of claim 15, wherein the displacement sensor comprises an inductive displacement sensor.

17. The system of claim 16, wherein the inductive displacement sensor comprises an elongate wire and an induction coil circumscribing the elongate wire, wherein the elongate wire is free to move within the induction coil, along an elongate axis of the coil.

18. The system of claim 17, wherein the elongate wire comprises a high magnetic permeability portion.

19. The system of claim 17, wherein the induction coil is wound on a polyimide tube, the elongate wire is encased in a tubular steel cover and the tubular steel cover is attached to the polyimide tube by a flexible silicone tube.
